(19) United States
(12) Patent Application Publication
(10) Pub. No.: US 2026/0288617 A1
(43) Pub. Date: Sep. 24, 2026

(54) SYSTEM AND METHOD FOR IDENTIFYING MULTIPLE IMPLEMENTATIONS OF THE SAME BUSINESS RULE WITHIN A SOFTWARE APPLICATION

(71) Applicant: HATHA SYSTEMS, LLC, Washington, DC (US)

(72) Inventors: Mike Oara, Washington, DC (US); Mikhail BULYONKOV, Novosibirsk (RU); Rama S. MOORTHY, Washington, DC (US)

(21) Appl. No.: 19/575,358

(22) Filed: Mar. 23, 2026

Related U.S. Application Data
(60) Provisional application No. 63/775,625, filed on Mar. 21, 2025.

(51) Int. Cl. G06F 11/3604; G06F 8/41; G06F 8/75

(52) U.S. Cl. CPC G06F 11/3604; G06F 8/433; G06F 8/75

(57) ABSTRACT

A system for identifying multiple implementations of a business rule within a software application comprising a data extraction unit for extracting programmatic elements from source code of the software application, a storage unit for storing the extracted programmatic elements, an application model unit for generating application model data representing structural and logical relationships among the extracted programmatic elements, and a business rule identification unit for identifying, based on the application model data, a plurality of candidate business rules, where each of the plurality of candidate business rules are associated with one or more implementations in the source code. The business rule identification unit can include a rule similarity unit for evaluating a degree of similarity between implementations of the plurality of candidate business rules, and to generate similarity data indicative of a similarity score quantifying the degree of correspondence between the implementations of the plurality of candidate business rules.

### RELATED APPLICATIONS

The present application claims priority to U.S. provisional patent application Ser. No. 63/775,625, filed on Mar. 21, 2025, and entitled System And Method For Identifying Multiple Implementations Of The Same Business Rule In A Software Application, the contents of which is herein incorporated by reference.

### BACKGROUND OF THE INVENTION

The present invention relates generally to the identification, analysis, and management of business rules within one or more software applications, and more particularly relates to the discovery and correlation of duplicate business rules that are implemented in multiple, disparate forms within a single software application.

In modern enterprise software systems, business rules govern how data is validated, transformed, calculated, authorized, and persisted. Examples of business rules include eligibility determinations, pricing calculations, discount policies, compliance checks, approval thresholds, posting logic to financial ledgers, and the like. The business rules embody the organization's operational and regulatory requirements and are therefore important to system correctness and governance.

However, in many software applications, particularly those that have evolved over time, identical or substantially similar business rules can be implemented in multiple locations and in different forms within a software application. For example, a credit approval threshold rule may be implemented in a user interface layer to provide immediate feedback, re-implemented in a service layer for transactional enforcement, and again embedded in a batch processing job for periodic reconciliation. Although each implementation may represent the same underlying business rule, the logic may be expressed using different variable names, data structures, programming languages, or architectural patterns. In some instances, minor variations may be introduced over time, resulting in logically inconsistent implementations of what was originally intended to be a single business rule.

This multiplicity of implementations of essentially the same business rule creates significant technical and operational challenges. When a business policy changes, developers typically need to locate all instances of the corresponding business rule throughout the application. Because the same rule may be expressed differently in different modules within the software application, such as through conditional statements in one component, configuration tables in another, and stored procedures in yet another, identifying all relevant implementations requires substantial manual effort, if possible at all. Failure to update every instance of the business rule can result in inconsistent system behavior, data integrity issues, compliance violations, and increased maintenance costs.

In the context of software maintenance, when an error or unexpected behavior is detected, a developer may need to determine not only how data flowed through the system, but also which business rules were applied to the data at each stage. This includes identifying where validations occurred, where calculations were performed, and whether alternative rule paths were triggered under specific conditions. In auditing or regulatory review contexts, analysts may need to confirm that specific business policies, such as revenue recognition rules or access control constraints, are applied uniformly across all relevant system components. In modernization initiatives, system architects may wish to extract and centralize business rules into services or rule engines, which requires first identifying all existing implementations of those rules across legacy codebases.

Conventional software analysis tools typically lack the ability to identify semantically equivalent business rules that are implemented differently across software components of a software application. They are not well suited to recognizing that distinct code segments, configuration entries, or database procedures collectively embody the same underlying business rule or policy. As a result, organizations lack a reliable mechanism for discovering, correlating, and managing multiple implementations of the same business rule within a single application.

### SUMMARY OF THE INVENTION

Accordingly, there is a need for systems and methods that can identify semantically or structurally similar implementations of a business rule within a software application, correlate multiple distinct implementations of the same underlying rule, and provide visibility into where and how such rules are enforced throughout the application. The present invention addresses these and other technical challenges.

The rule identification system of the present invention is configured to identify business rules implemented within a software application and to detect multiple implementations of the same or similar business rule (e.g., duplicates) within the application source code. Software applications often evolve over time, resulting in the same business rule being implemented multiple times across different programs, modules, or components. These implementations may differ syntactically or structurally even though they represent the same underlying business logic. The rule identification system of the present invention provides mechanisms for discovering such rule implementations and correlating them to identify duplicated or replicated business rule logic.

The rule identification system analyzes source code associated with a software application to extract programmatic elements indicative of business rules. Such programmatic elements may include, for example, data elements, definitions, operations, relationships, code snippets, and associated software artifacts. The extracted information may be stored in an application model repository that represents structural and logical relationships present within the application. Based on the extracted programmatic elements, the rule identification system identifies candidate business rules and associates each rule with one or more implementations corresponding to specific locations in the source code where the rule logic is embodied.

The rule identification system further includes a rule similarity unit configured to identify potential duplicate business rules and to evaluate similarities among the candidate business rule implementations. The rule similarity unit may employ one or more similarity techniques, including syntactic comparison of code snippets, semantic comparison of rule logic, comparison of data elements referenced by the rules, and analysis of structural or contextual relationships within the application. Based on these techniques, the rule similarity unit may generate similarity data, including similarity scores and lists of candidate rule implementations that satisfy selected similarity criteria.

The system can further include a rule correlation unit configured to correlate or group business rules determined to represent the same or substantially similar business logic and hence can be deemed to be duplicate business rules. The rule correlation unit may automatically correlate rules that satisfy predefined similarity conditions, such as exceeding a specified similarity threshold. In other embodiments, the system may present candidate similar rules to a user through a graphical interface, allowing the user to review the candidate rules and manually select rules that should be considered equivalent or related. The correlated rules may then be associated with a single conceptual business rule representation.

Through the identification and correlation of multiple implementations of the same business rule, the rule identification system enables improved visibility into business logic distributed throughout a software application. The system assists users (e.g., developers and analysts) in locating instances of a business rule within the application, thereby facilitating maintenance, modification, and auditing of business logic. In addition, the invention supports identification of duplicated rule logic and promotes consolidation and reuse of business rules, thereby improving consistency and maintainability of software applications.

The present invention is directed towards a system for identifying multiple implementations of a business rule within a software application, comprising a data extraction unit configured to extract programmatic elements from source code of the software application; a storage unit configured to store the extracted programmatic elements; an optional application model unit configured to generate application model data representing structural and logical relationships among the extracted programmatic elements; and a business rule identification unit configured to identify, based on the application model data, a plurality of candidate business rules, each of the plurality of candidate business rules associated with one or more implementations in the source code. The business rule identification unit can include a rule similarity unit configured to evaluate a degree of similarity between implementations of the plurality of candidate business rules and to generate similarity data indicative of a similarity score quantifying the degree of correspondence between the implementations of the plurality of candidate business rules.

The business rule identification unit can further include a rule correlation unit configured to correlate, based on the similarity data, two or more of the implementations of the plurality of business rules to represent the same business rule, and to generate rule correlation data indicative of a grouping of the correlated implementations of the plurality of business rules under a single business rule representation. The rule similarity unit can also be configured to evaluate the extracted programmatic elements to generate the similarity score that quantifies the degree of correspondence between selected ones of the implementations of the plurality of candidate business rules. The rule similarity unit is further configured to compare the programmatic elements associated with an implementation of a reference business rule with the programmatic elements associated with one or more of the implementations of the plurality of candidate business rules, and based on this comparison, generate the similarity score.

Further, each of the implementations in the source code includes positional information identifying a location in the source code where the business rule is embodied. The programmatic elements can include at least one of data elements, definitions, operations, code snippets, and relationships present in the source code. The rule similarity unit is configured to apply a rule similarity technique to the extracted programmatic elements to determine the degree of similarity between the implementations of the plurality of candidate business rules. The similarity technique can include one or more of a syntactic similarity technique, a semantic similarity technique, a data-element similarity technique, and a structural or contextual similarity technique.

The rule similarity unit can be configured to analyze relationships among the programmatic elements, including one or more of control-flow relationships, data-flow relationships, and invocation relationships, that indicate the implementations of the plurality of candidate business rules. The rule similarity unit is further configured to generate a composite similarity score by combining similarity scores obtained from two or more of the similarity techniques. Further, the rule similarity unit is configured to receive a user-defined similarity threshold and to identify, from the application model data, the implementations of the plurality of candidate business rules satisfying the similarity threshold as potential implementations of a reference business rule.

The system can also include a user interface generator configured to generate a graphical user interface that presents a list of the implementations of the plurality of candidate business rules satisfying the similarity threshold, and that receives user input related to individual ones of the plurality of candidate business rules as implementations of the reference business rule. For example, the user interface generator can be configured to generate a first user interface having a search field through which a user enters or selects a reference business rule for use as a basis for a code-syntax-based similarity search of the application model data, and to generate a second user interface displaying the plurality of candidate business rules identified as a result of the code-syntax-based similarity search. Alternatively, the user interface generator can be configured to generate a first user interface having a search field through which a user enters a text-based input as a basis for a text-based similarity search of the application model data, and to generate a second user interface displaying the plurality of candidate business rules identified as a result of the text-based similarity search. The data elements can include at least one of variables, parameters, constants, fields, attributes, and database columns referenced by the source code; wherein the definitions include at least one of declarations and structural constructs defining data structures, classes, methods, or functions; wherein the operations include at least one of conditional statements, comparison operations, assignment statements, calculations, loops, and function calls that embody validation, computation, or decision logic; and wherein the relationships include at least one of data-flow relationships, derivation relationships, invocation relationships among programs or functions, and control-flow relationships within the source code. The rule correlation data can also be stored in the application model data and is presented through a user interface for review and confirmation by a user.

The present invention is also directed to a method for identifying multiple implementations of a business rule within a software application. The method can comprise extracting, with a data extraction unit, programmatic elements from source code of the software application; storing the extracted programmatic elements in a storage unit; generating, with an application model unit, application model data representing structural and logical relationships among the extracted programmatic elements; and identifying, with a business rule identification unit and based on the application model data, a plurality of candidate business rules, each of the plurality of candidate business rules associated with one or more implementations in the source code; and evaluating, with a rule similarity unit forming part of the business rule identification unit, a degree of similarity between implementations of the plurality of candidate business rules and generating similarity data indicative of a similarity score quantifying the degree of correspondence between the implementations of the plurality of candidate business rules.

The method can also include correlating, with a rule correlation unit forming part of the business rule identification unit and based on the similarity data, two or more of the implementations of the plurality of business rules to represent the same business rule, and generating rule correlation data indicative of a grouping of the correlated implementations of the plurality of business rules under a single business rule representation. The method can also include, with the rule similarity unit, evaluating the extracted programmatic elements to generate the similarity score by quantifying a degree of correspondence between selected ones of the implementations of the plurality of candidate business rules; comparing the programmatic elements associated with an implementation of a reference business rule with the programmatic elements associated with one or more of the implementations of the plurality of candidate business rules; and based on this comparison, generating the similarity score.

The method can also be configured for applying, with the rule similarity unit, a rule similarity technique to the extracted programmatic elements to determine the degree of similarity between the implementations of the plurality of candidate business rules. The rule similarity technique can include one or more of a syntactic similarity technique, a semantic similarity technique, a data-element similarity technique, and a structural or contextual similarity technique. The method can also generate, with the rule similarity unit, a composite similarity score by combining similarity scores obtained from two or more of the similarity techniques, and identify from the application model data, with the rule similarity unit when receiving a user-defined similarity threshold, the implementations of the plurality of candidate business rules satisfying the similarity threshold as potential implementations of a reference business rule.

The method also includes generating, with a user interface generator a graphical user interface that presents a list of the implementations of the plurality of candidate business rules satisfying the similarity threshold, and receiving user input related to individual ones of the plurality of candidate business rules as implementations of the reference business rule. Still further, the method includes generating, with a user interface generator, a first user interface having a search field through which a user enters or selects a reference business rule for use as a basis for a code-syntax-based similarity search of the application model data; and generating, with the user interface generator, a second user interface displaying the plurality of candidate business rules identified as a result of the code-syntax-based similarity search. Still further, the method includes generating, with a user interface generator, a first user interface having a search field through which a user enters a text-based input as a basis for a text-based similarity search of the application model data; and generating, with the user interface generator, a second user interface displaying the plurality of candidate business rules identified as a result of the text-based similarity search.

The present invention is also directed to a non-transitory computer-readable medium storing computer program instructions that, when executed by at least one processor, cause the at least one processor to perform operations for identifying multiple implementations of a business rule within a software application, the operations comprising extracting programmatic elements from source code of the software application; generating application model data representing structural and logical relationships among the extracted programmatic elements; identifying, based on the application model data, a plurality of candidate business rules, wherein each of the plurality of candidate business rules associated with one or more implementations in the source code; evaluating a degree of similarity between implementations of the plurality of candidate business rules; and generating similarity data indicative of a similarity score quantifying the degree of correspondence between the implementations of the plurality of candidate business rules.

The non-transitory computer-readable medium further includes correlating, based on the similarity data, two or more of the implementations of the plurality of business rules to represent the same business rule, and generating rule correlation data indicative of a grouping of the correlated implementations of the plurality of business rules under a single business rule representation. The non-transitory computer-readable medium of claim 27 can also include evaluating the extracted programmatic elements to generate the similarity score by quantifying a degree of correspondence between selected ones of the implementations of the plurality of candidate business rules; comparing the programmatic elements associated with an implementation of a reference business rule with the programmatic elements associated with one or more of the implementations of the plurality of candidate business rules; and based on this comparison, generating the similarity score. Still further, the non-transitory computer-readable medium includes applying a rule similarity technique to the extracted programmatic elements to determine the degree of similarity between the implementations of the plurality of candidate business rules. The similarity technique comprises one or more of a syntactic similarity technique, a semantic similarity technique, a data-element similarity technique, and a structural or contextual similarity technique.

The non-transitory computer-readable medium can include generating a graphical user interface that presents a list of the implementations of the plurality of candidate business rules satisfying the similarity threshold, and receiving user input related to individual ones of the plurality of candidate business rules as implementations of the reference business rule. Stil further, the non-transitory computer-readable medium includes generating a first user interface having a search field through which a user enters or selects a reference business rule for use as a basis for a code-syntax-based similarity search of the application model data, and generating a second user interface displaying the plurality of candidate business rules identified as a result of the code-syntax-based similarity search.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention.

FIG. 1 is a schematic block diagram of the rule identification system according to the teachings of the present invention.

FIG. 2 is a schematic block diagram of the details of the business rule identification unit of FIG. 1 according to the teachings of the present invention.

FIG. 3 is a schematic representation of code snippets within source code of the software application representing one or more business rules according to the teachings of the present invention.

FIG. 4 is an exemplary user interface generated by the user interface generator of FIG. 1 showing the entry of business rule data according to the teachings of the present invention.

FIGS. 5A and 5B are exemplary user interfaces generated by the user interface generator of FIG. 1 showing the search and identification of business rules using code syntax data according to the teachings of the present invention.

FIGS. 6A and 6B are exemplary user interfaces generated by the user interface generator of FIG. 1 showing the search and identification of business rules using text-based data according to the teachings of the present invention.

FIGS. 7A and 7B are exemplary user interfaces generated by the user interface generator of FIG. 1 showing the selection of identified business rules using and the correlation together according to the teachings of the present invention.

FIG. 8 is a schematic diagram of an electronic device and/or associated system suitable for implementing the process flow identification system of the present invention.

### DETAILED DESCRIPTION

The present invention is directed to a system and method for identifying multiple different implementations of the same business rule inside the code of a software application. The business rule discovery is important as the recoding of the same business rule in multiple places may lead to superfluous code and contradictions as to how the business rule is being applied. By using the system and method of the present, the superfluous or contradictory implementations of the business rule may be avoided.

The rule identification system of the present invention operates in conjunction with code analysis techniques to discover how business rules are implemented within the source code of a software application. For example, a static analysis process may be applied to the source code of the application in order to construct an internal representation or model of the software system. During this process, the source code may be parsed and analyzed to identify programmatic elements and structural relationships within the application. Information derived from this analysis may be stored in a repository, data store, or knowledge base that maintains representations of the application components, code snippets, data elements, and other programmatic elements identified in the source code.

Using the information stored in a repository, the rule identification system may perform analysis and queries to discover business rules implemented within the code base. The discovery process may result in the identification of a collection of business rules detected within the application. For each identified business rule, the system may maintain a corresponding set of rule implementations indicating where the rule is embodied in the source code. In certain embodiments, each implementation of a business rule may include information identifying the software artifact in which the rule appears, such as the name or identifier of the source file, program, module, or component containing the rule logic, as well as positional information indicating the location of the code snippet implementing the rule, such as the starting and ending line numbers of the source code segment. Each conceptual business rule can be implemented once within a software application and reused wherever the rule is applied. In such an architecture, the business rule logic may be encapsulated in a single program, method, service, or module that can be invoked from multiple locations within the application, thereby ensuring consistent behavior and simplifying maintenance. However, in many real-world software systems, particularly those that have evolved over time through incremental development and modification, developers frequently replicate or reimplement the same business rule logic in multiple locations within the code base. These multiple implementations may occur across different programs, modules, services, or components of the application.

The existence of multiple implementations of the same business rule can introduce several technical and operational challenges. First, when the underlying business policy represented by the rule changes, users (e.g., developers) need to locate every instance in which the rule has been implemented and update each implementation accordingly. If one or more implementations are overlooked during such modifications, the application may exhibit inconsistent or erroneous behavior. Second, independently developed implementations of the same business rule may differ in subtle ways due to variations in coding style, variable naming, or interpretation of the rule requirements. These inconsistencies can lead to incorrect calculations, inconsistent validations, or other operational errors within the application.

Accordingly, it is desirable for software applications to reuse business rule logic rather than duplicate it across multiple locations in the code. The rule identification system described herein provides mechanisms for identifying and correlating multiple implementations of the same business rule within a code base. In certain embodiments, the system can analyze the code of an application to determine whether a business rule known to have at least one implementation in the code base has additional implementations elsewhere within the same application. The system may employ the similarity identification techniques described herein to locate probable additional implementations of the rule by comparing programmatic elements associated with candidate rule implementations.

In certain other embodiments, the rule identification system allows a user to specify a degree of similarity required for two candidate rule implementations to be considered implementations of the same business rule. Based on the selected similarity threshold, the system may generate a list of potential additional implementations of the business rule within the code base. The user may review the identified candidate implementations and determine which of the candidates represent true implementations of the same business rule and which represent false positives. Once confirmed, the multiple implementations of the business rule may be recorded, reported, or presented through a user interface, thereby enabling developers, analysts, or system administrators to understand where the rule logic appears throughout the application. By providing visibility into duplicated or replicated rule logic, the system assists in improving code maintainability, reducing inconsistencies, and supporting the consolidation or reuse of business rule implementations across the software application.

The term “operator” is used to designate the human or end user who is utilizing the system and the method of the present invention.

The term “end user” is used to refer to a user of the software application or associated computer system.

The term “software artifact” or “technical artifact” is intended to include an object which plays a role in the architecture and the running of a software application, such as a user interface (e.g., a screen or a window), a program or a data store. Software artifacts are defined by the developers of the software application such that, at runtime, the artifacts combine to support the functionality of the application. In different types of technologies, the program may also be called functions, procedures, or methods.

The term “data store” as used herein is intended to include any physical or logical device which holds or stores data, including data processed by the software application. The data stores can include tables, records, segments, indexed or sequential files, and the like.

The term “user interface” as used herein refers to any software artifact in a software application, which is used to present data to an operator or end user or acquire data from an operator or end user. The user interfaces can include screens, windows, panes, forms, pages or reports.

The term “program” as used herein refers to a discrete set or sequence of computer-executable instructions that are stored in a non-transitory medium and that, when executed by one or more processors, perform a specific task or function. A program may be embodied in human-readable form (e.g., source code), intermediate form (e.g., bytecode), or machine-executable form (e.g., object code or executable code). The program may include one or more modules, routines, procedures, classes, methods, scripts, or other code constructs, and is generally directed to a defined functional objective within a larger system. A program may operate independently or may be invoked by, or invoke, other programs.

The term “application” or “software application” as used herein refers to a broader software system comprising a plurality of programs and associated software artifacts that collectively provide integrated functionality for use by an end user, organization, or other system. A software application may include, for example, multiple executable programs, libraries, services, application programming interfaces (APIs), configuration files, database schemas, stored procedures, user interface components, and other related software artifacts that cooperate to implement business processes or operational workflows. The programs within a software application may communicate with one another through procedural calls, service interfaces, messaging mechanisms, shared data stores, or other communication techniques. Accordingly, a software application encompasses an organized aggregation of interrelated programs and supporting components, whereas a program represents a discrete executable unit within such an application. The application can have associated source code which can be programmatically called or can programmatically call other such procedural calls or that can communicate with a software artifact.

The term “application model” as used herein is intended to mean or include a data model consisting of entities, relationships and their associated attributes, collected through an extraction process (e.g., a reverse engineering process) and stored in selected memory or storage (e.g., files or a database). The entities can include programs, classes, statements, data elements, tables, columns, or screens. The attributes can include for example any associated identifying information, such as name, size, identification (ID) or kind that can further specify each entity. The entities may be related through relationships such as statement read fields, program update tables, program calls, and the like.

The term “code snippet,” “snippet of code,” or “snippets of code” as used herein refers to a contiguous set of statements, instructions, or lines of source code within a program or software application that collectively implement a particular portion of logic. A code snippet may include, for example, a conditional construct (such as an IF statement together with associated THEN and ELSE branches), a loop construct (such as a WHILE or FOR statement), a sequence of assignment or computational statements, a method body, or any other contiguous fragment of executable logic. A code snippet is a concrete portion of source code as written in a programming language and is distinct from “code syntax,” which refers to the grammatical or structural rules of a programming language that govern how statements must be formed. Thus, while a code snippet is expressed using the syntax of a particular programming language, the term “code snippet” refers to the substantive fragment of logic embodied in contiguous code, independent of the specific syntactic form or language in which that fragment is written.

The term “business rule” as used herein refers to or means a predefined policy, constraint, condition, computation, decision logic, or operational directive that governs how data is validated, computed, derived, restricted, authorized, processed, or otherwise treated within a software application in order to conduct or support a business. A business rule may define, for example, a required condition (e.g., a customer must be at least 18 years old), a computational relationship (e.g., charge=price-discount+tax), a constraint (e.g., a loan cannot be approved if a credit score is below a threshold), a structural or domain limitation, a trigger based on an event, an authorization requirement, a workflow condition, or a temporal restriction. Business rules are generally conceptual or abstract in nature in that they reflect business policies or requirements independent of any particular software implementation. However, within a software application, such rules are typically embodied, enforced, or executed through one or more fragments or snippets of source code, configuration elements, database procedures, or other executable logic. A single abstract business rule may be implemented one or more times within the same application or across multiple applications, whether through reuse of shared code, invocation of common services, or duplication of similar logic in different components. A business rule is therefore distinct from the specific code that implements it, and not all source code constitutes a business rule, as certain code may relate solely to technical or presentation functions without embodying a business policy or decision. A business rule discovery process involves identifying the associated business rule, but also the implementation of the rule in the source code. The same abstract rule may be implemented multiple times in the code of an application, either by reuse of the same code via programmatic calls, or by simple duplication or replication of the code.

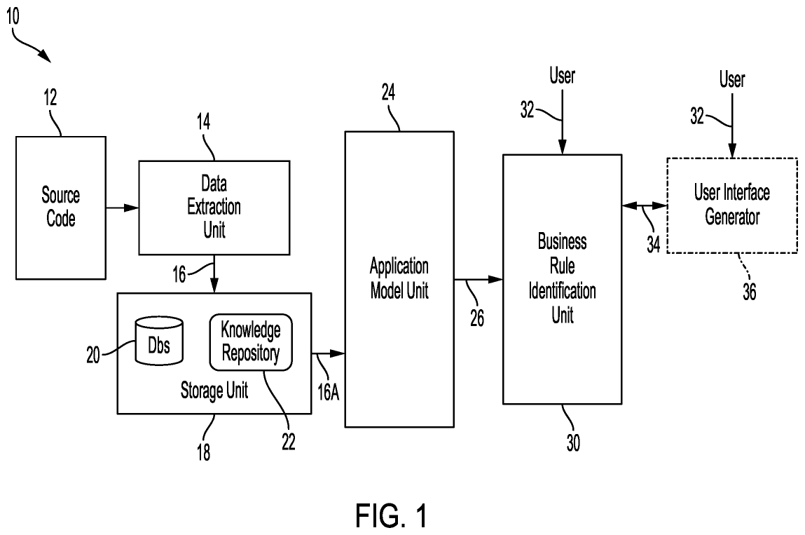

The rule identification system 10 of the present invention is shown for example in FIG. 1. The illustrated rule identification system 10 can employ one or more computing systems or one or more electronic devices that have one or more units, modules, systems, or sub-systems that are configured to implement the functionality described herein. According to the present invention, the rule identification system 10 helps identify selected data, such as data or values associated with business rules, within a software application. The illustrated system 10 includes one or more data sources 12 for storing source code that is associated with a software application, such as for example program source code or database or screen descriptions. The system 10 can also include a data extraction unit 14 that can identify and extract selected types of information, such as programmatic elements, from the source code. According to one embodiment of the present invention, the data extraction unit 14 extracts the types of data that allows the system 10 to subsequently identify, determine and represent business rules, as well as optionally the relationship between software artifacts (e.g., user interfaces, programs and data stores). For example, the data extraction unit 14 employs extraction techniques to analyze the source code of a software application and to extract information, such as the programmatic elements, that is indicative of, or representative of, business rules implemented within the software application. The programmatic elements can include, for example, data elements, statements, definitions, operations, code snippets, software artifacts, and relationships associated with the code. Data elements may include variables, parameters, constants, fields, attributes, database columns, or other data structures referenced by the code. Definitions may include declarations or structural constructs defining data structures, classes, methods, functions, or other software artifacts. Operations may include executable statements or expressions, such as conditional statements, comparison operations, assignment statements, calculations, loops, and function calls that embody validation, computation, or decision logic. Relationships may include dependencies or associations among programmatic elements, including data flow relationships, derivation relationships, invocation relationships among programs or functions, and control-flow relationships within the code. The programmatic elements provide information indicative of the business rules implemented within the software application.

Specifically, the programmatic elements can characterize how business logic is implemented in the source code. For example, the extracted programmatic elements can include program statements or code snippets that implement logic associated with business rules. Such statements may include conditional constructs (e.g., IF/THEN/ELSE statements, CASE statements, or other branching logic), iterative constructs (e.g., WHILE or FOR loops), computational expressions, assignment statements, comparison operations, or other sequences of executable statements that embody validation conditions, calculations, constraints, or decision logic. The extracted data 16 may also include data elements that participate in rule logic. These data elements may include variables, parameters, constants, fields, attributes, database columns, records, or other data structures referenced by the code snippets implementing the rule. In certain embodiments, relationships among data elements, such as dependencies or derivation relationships between input values and computed values, may also be identified and extracted. Additionally, the extracted data 16 can also include software artifacts that provide contextual information regarding where and how the business rule logic is implemented within the software application. The software or technical artifacts may include programs, modules, classes, methods, functions, services, stored procedures, database triggers, configuration elements, or other components of the application in which the relevant code snippets appear. Identifying the associated software artifacts allows the system to determine the locations within the application where particular rule logic is implemented. The extracted data 16 may further include operational and structural characteristics associated with the rule implementation, such as references to external services or databases, invocation relationships between programs or modules, input and output parameters, and the flow of data between components. Collectively, the extracted information enables the rule identification system 10 to detect candidate business rules within the source code, characterize their logical structure, and identify multiple implementations of the same or similar business rules across different portions of the software application. The candidate business rules are potential or suspected duplicate business rules identified during analysis of the software application but not yet confirmed as final or consolidated rules. They are essentially intermediate detection results produced by the rule discovery process. The data extraction unit 14 can be implemented using known reverse engineering methods, such as for example by using software analysis tools, and preferably software static analysis tools. Examples of suitable software static analysis tools includes Apache Yetus, Axivion Bauhaus, Coverity, and the like.

The extracted data 16 can be stored in a storage unit 18. The storage unit 18 can be any selected type of storage unit 18 as is known in the art. According to one practice, the storage unit 18 can include a database 20 for storing the extracted data 16. The database 20 can be any type of database, and is preferably a relational database. The database 20 functions as a storage device for an optional knowledge repository 22, which can be implemented in connection with (e.g., on top of) the database 20, and which can be configured to also store the extracted data 16, which can include for example programmatic elements indicative or representative of the business rules (e.g., software artifacts, data elements and program statements). Consequently, the knowledge repository 22 can be used to store and make available for retrieval information associated with and about the software application and associated data. In particular, the knowledge repository 22 stores information about which statements appear in the application, which data elements are used in each statement, which data elements and which scripts appear on each user interface, which columns or fields appear in which data stores, which procedures are triggered by operations against tables, which programs call which programs, which programs communicate with which user interfaces, which programs access which data stores, and the like.

The rule identification system 10 also includes an optional application model unit 24 that includes all of the extracted data 16, which includes the programmatic elements, such as software artifacts, entities, relationships and associated attributes. As such, the application model can be employed as a convenient source of information about the software application being analyzed by the system. The entities can include programs, classes, statements, data elements, data stores such as tables, columns, or screens. The attributes can include for example any associated identifying information that can further specify the entity. The entities may be related through relationships such as statement read fields, program update tables, program calls, or program communications with for example a screen. The application model unit 24 can generate application model information 26 indicative or representative of the application model that is conveyed to other portions of the system. The application model information 26 can include information or data associated with the business rules with the software artifacts and the software application and associated programs.

In certain embodiments, the rule identification system 10 may operate on a collection or repository of previously identified business rules associated with a software application. Each business rule in the collection may represent a conceptual rule governing validation, computation, decision logic, or other business-related processing performed within the application. At a minimum, each business rule may be associated with a unique identifier that distinguishes the rule from other rules stored in the repository. The identifier may be represented, for example, as a rule name, numeric identifier, label, or other reference that allows the rule to be uniquely referenced and managed within the system. In addition to the identifier, each business rule may be associated with one or more implementations representing locations within the source code where the logic corresponding to the rule is embodied. Each implementation may include information identifying the software artifact in which the rule logic appears, such as a source file, program, module, method, function, service, or other code component. The implementation record may further include positional information identifying the specific location of the code snippet that implements the rule within the corresponding source artifact. For example, the positional information may include the starting and ending line numbers, character offsets, or other markers indicating the precise region of the source code in which the rule implementation is located. In this manner, the system maintains a structured representation linking each business rule to the specific segments of source code that implement the rule within the software application.

The illustrated rule identification system 10 also includes a business rule identification unit 30 that can identify business rules in the source code and can form a list of the business rules so as to allow the user to identify and correlate similar or instances of the same business rule within the software application. The business rule identification unit 30 can analyze the application model data 26 in the application model and identify selected patterns in the code, such as snippets of code, which can thus be associated with one or more business rules. That is, the business rule identification unit 30 identifies the business rules that are present in the applications model. According to one embodiment, the operator or user can simply employ the user interfaces of the system 10 to view, add or select the identified business rules thereto, and then for each business rule specify if desired the snippets of code which embody the rules. This process, however, can be inefficient and error prone, as the user may forgot to either add business rules or fail to specify all possible embodiments of the rules. According to a more efficient implementation, the operator can start with an operator-defined code pattern (i.e., snippet of code) and the system 10 can search for the code pattern in the source code of the application. The search results in the discovery of a number of code snippets which conform to the searched pattern. The system 10 can create a business rule from each snippet of code or code snippet found by the code pattern search and then mark the code snippet as the embodiment of that business rule.

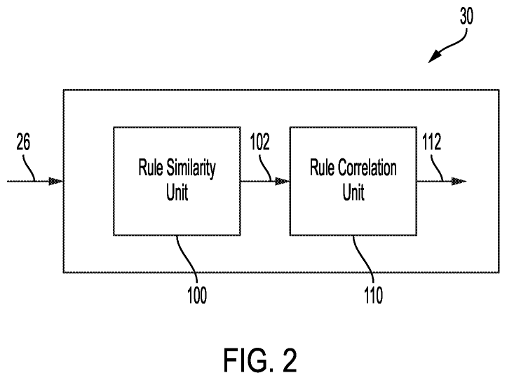

Selected details of the business rule identification unit 30 are shown for example in FIG. 2. The illustrated business rule identification unit 30 can include a rule similarity unit 100 configured to determine whether two or more detected candidate business rules represent implementations of the same underlying or conceptual business rule. Because a single conceptual business rule may be implemented multiple times within a software application, often using different variables, expressions, structures, or programming language syntax, the rule similarity unit 100 enables the system or user to specify a degree, amount or threshold of similarity that exists between candidate business rule implementations before those candidate implementations are potentially deemed to correspond to the same business rule.

For example, the rule similarity unit 100 can be configured to analyze the programmatic elements extracted from the source code 12 that are indicative of the business rules. As described herein, such programmatic elements may include data elements, definitions, operations, relationships, code snippets, and associated software artifacts. The rule similarity unit 100 can be configured to compare programmatic elements associated with a selected or reference business rule implementation with programmatic elements associated with other candidate business rule implementations identified within the application model data. Based on this comparison, the rule similarity unit 100 evaluates the extracted programmatic elements to generate one or more similarity measures or scores that quantify the degree of correspondence between the candidate business rule implementations. The comparison may consider, for example, similarities in conditional expressions, computational formulas, comparison operations, assignments, and other logical constructs embodied in code snippets implementing the business rule. The comparison may further consider similarities among the data elements involved in the rule logic, such as variables, parameters, fields, or database columns referenced by the rule, as well as similarities in the relationships among those elements, including data flow relationships, derivation relationships, or other associations among the programmatic elements.

According to other embodiments, the rule similarity unit 100 can be configured to apply one or more similarity techniques to the business rule data to determine the degree of similarity between candidate rule implementations. For example, the rule similarity unit 100 can employ a syntactic similarity technique in which the structural form of code snippets implementing the candidate business rules is compared at one or more levels of abstraction. In certain embodiments, the rule similarity unit 100 can tokenize the code snippets to identify constituent code elements, such as keywords, operators, identifiers, literals, and control structures, and perform token-based comparisons between corresponding sequences of tokens. The token sequences can be normalized prior to comparison, for example by removing formatting differences, standardizing naming conventions (e.g., variable and function names), abstracting literal values, or otherwise reducing syntactic variations that do not affect the underlying logic. The rule similarity unit 100 can be optionally further configured to further generate structural representations of the code snippets, such as for example abstract syntax trees (ASTs), parse trees, or other hierarchical models, that represent the syntactic organization of the code. The rule similarity unit 100 can be configured to compare such structural representations by evaluating correspondences between nodes, subtrees, or paths within the trees, including control-flow constructs (e.g., conditional branches, loops), expression trees, and statement groupings. The comparison may also account for variations in statement ordering, nesting depth, or grouping of operations by applying normalization or canonicalization techniques to the structural representations. In certain embodiments, the syntactic similarity technique may further include computing similarity measures based on edit distance, tree distance, pattern matching, or other structural comparison metrics applied to the tokenized or tree-based representations. For example, the rule similarity unit 100 may determine a degree of similarity based on the number of insertions, deletions, or substitutions required to transform one code snippet into another, or based on the extent to which substructures within the code snippets match predefined patterns associated with business rule logic. These approaches enable the rule similarity unit 100 to identify similarities in the structural and logical organization of code snippets even when superficial differences exist in formatting, naming, or other syntactic characteristics, thereby improving the detection of multiple implementations of the same or similar business rule.

In certain embodiments, the rule similarity unit 100 can employ a semantic similarity technique that analyzes the functional meaning or logical effect of the business rule implementations. For example, the rule similarity unit 100 may compare computational expressions, logical conditions, or validation criteria implemented by the business rules to determine whether the rules produce equivalent or substantially similar outcomes. Semantic similarity techniques may include normalization of expressions, evaluation of logical equivalence among conditional statements, or analysis of derivation relationships between input and output data elements. Further, the similarity technique applied by the rule similarity unit 100 can include a data-element similarity technique in which the rule similarity unit 100 evaluates the correspondence between the data elements referenced by candidate business rule implementations. For example, the rule similarity unit 100 can compare variable names, parameters, fields, attributes, or database columns involved in the rules. Such comparisons may be based on naming similarity, previously identified mappings between business terms, shared data lineage, schema relationships, or other associations indicating that two data elements represent the same conceptual business data. Still further, the similarity technique can include a structural or contextual similarity technique that considers the context in which the business rule implementations appear within the software application. For example, the rule similarity unit 100 can analyze the software artifacts in which the business rule logic is implemented, such as programs, modules, methods, services, stored procedures, or other components. The rule similarity unit 100 may further analyze relationships among programmatic elements, such as control-flow relationships, data-flow relationships, invocation relationships between functions or services, or other structural associations that may indicate related rule implementations.

According to other embodiments, the rule similarity unit 100 can be configured to employ a data-element similarity technique in which data elements referenced by candidate business rule implementations are analyzed to determine the degree of similarity between the rules. In such embodiments, the rule similarity unit 100 can be configured to identify and extract data elements associated with each code snippet implementing a candidate business rule, including, for example, variables, parameters, constants, attributes, fields, database columns, records, or other data structures referenced by the rule logic. The rule similarity unit 100 can then compare the identified data elements across different candidate rule implementations to determine whether the rules operate on the same or related business data. The rule similarity unit 100 can then be configured to normalize the identified data elements prior to comparison. For example, variable names and identifiers can be standardized, mapped to common business terms, or abstracted to remove superficial naming differences. The rule similarity unit 100 can also utilize naming similarity techniques, such as string comparison, pattern matching, or lexical analysis, to identify correspondences between differently named data elements that may represent the same underlying business concept. In addition, the rule similarity unit 100 may reference metadata, schema definitions, or data dictionaries to determine relationships between data elements, such as equivalence, synonymy, or hierarchical relationships. The data-element similarity technique can further analyze relationships among data elements, including data flow relationships, derivation relationships, and usage patterns within the code snippets. For example, the rule similarity unit 100 can determine whether two candidate rule implementations derive a value from similar input data elements, apply similar transformations to those inputs, or produce outputs that correspond to the same or related data structures. The unit may also consider the context in which data elements are used, such as their roles within conditional expressions, computational formulas, or validation logic. The rule similarity unit 100 can then compute similarity measures based on the degree of correspondence between sets of data elements associated with candidate rule implementations. For example, similarity scores can be based on the number or proportion of matching or related data elements, weighted by the significance of particular elements within the rule logic. These approaches enable the rule similarity unit 100 to identify candidate business rule implementations that operate on the same or similar business data, even when the implementations differ in code syntax, structure, or expression, thereby improving the detection of multiple implementations of the same or related business rule.

According to other embodiments, the rule similarity unit 100 can be configured to employ a structural or contextual similarity technique in which the surrounding structure and execution context of candidate business rule implementations are analyzed to determine the degree of similarity between the rules. In such embodiments, the rule similarity unit 100 may evaluate the software artifacts and program structures in which the code snippets implementing the candidate business rules are located, including, for example, programs, modules, classes, methods, functions, services, stored procedures, or other components of the software application. By analyzing these artifacts, the rule similarity unit 100 can determine whether candidate rule implementations occur in similar structural locations or play similar roles within the overall architecture of the application. The rule similarity unit 100 may analyze control-flow and execution context associated with the candidate rule implementations. For example, the unit may determine whether the rule logic appears within similar execution paths, such as user interface processing routines, transaction processing flows, batch jobs, or service-layer operations. The unit may also evaluate control-flow structures surrounding the rule implementations, such as nesting within conditional branches, loops, exception-handling blocks, or other control constructs, to identify similarities in how and when the rule logic is executed. In certain embodiments, the rule similarity unit 100 can further analyze invocation and dependency relationships among software artifacts associated with the candidate rule implementations. For example, the unit may determine whether the rule implementations are invoked by similar calling programs or services, whether they interact with similar external systems or data stores, or whether they participate in similar workflows or business processes. The unit may also evaluate call graphs, dependency graphs, or other representations of relationships among software artifacts to identify structural similarities between different portions of the application in which the rule logic appears. In certain embodiments, the structural or contextual similarity technique may include generating and comparing graph-based representations of the application structure, such as control-flow graphs, call graphs, or data-flow graphs associated with the candidate rule implementations. The rule similarity unit 100 may compare such graphs by evaluating similarities in nodes, edges, paths, or subgraphs corresponding to the rule logic and its surrounding context. Similarity measures may be computed based on the degree of correspondence between these structural representations, optionally applying weighting factors to emphasize particular contextual features, such as execution pathways or artifact relationships. These approaches enable the rule similarity unit 100 to identify candidate business rule implementations that are structurally or contextually similar, even when the underlying code snippets differ in syntax or expression. By incorporating structural and contextual information into the similarity analysis, the system improves its ability to detect multiple implementations of the same conceptual business rule across different components, layers, or execution contexts within the software application.

The rule similarity unit 100 can then be configured to optionally determine a similarity composite similarity score by combining results obtained from multiple similarity techniques. For example, syntactic similarity, semantic similarity, data-element similarity, and structural similarity measures may each contribute to an overall similarity metric. Weighting factors may be applied to different categories of programmatic elements so that certain aspects of the rule logic, such as conditional expressions or computational formulas, have greater influence in determining rule similarity than other aspects, such as formatting differences or variable naming conventions.

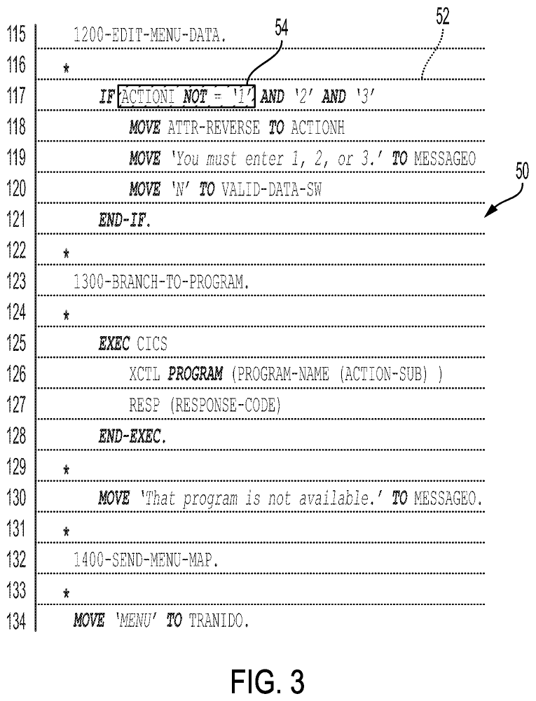

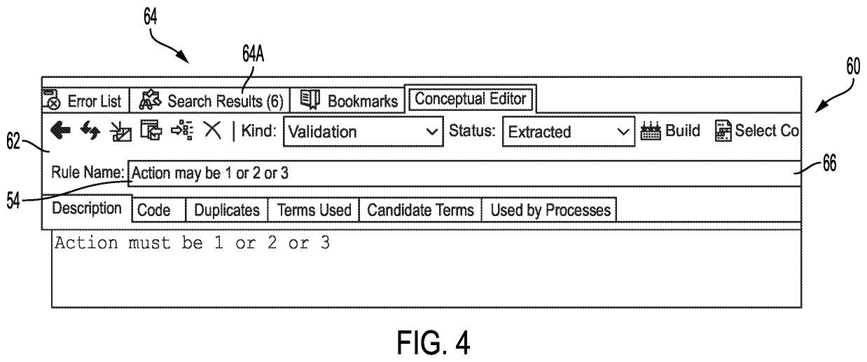

The rule identification system 10 can also include a user interface generator 36 that can be employed to generate one or more user interfaces that can be displayed on a suitable display device. The user interfaces can be configured to display information associated with the business rules, including one or more programmatic elements, and can provide for search and selection capabilities. According to one embodiment, as shown in FIG. 3, the user interface generator 36 can generate the illustrated user interface 50 that can list one or more of the programmatic elements associated with one or more of the business rules. The user interface 50 can set forth and display in a window 52 the code snippets associated with one or more business rules 56. The illustrated code lists, for example, the business rule 54 (e.g., Action1 NOT=‘1’ and ‘2’ and ‘3’). The user interface generator 36 can also generate the user interface 60, as shown in FIG. 4. The illustrated user interface 60 can include the window 62 that provides a series of menu elements 64, including a search menu element 64A. The window element 62 can also include a search field 66 that allows a user via suitable user input 32 to search for a selected business rule 54. For example, the user can provide user input 32 in the form of the name of a business rule and the business rule identification unit 30 can search for the business rule in the either the extracted data 16, the stored extracted data 16A, or in the application model data 26 corresponding to the business rules. For the sake of simplicity herein, the business rule data is described herein forms part of the application model data, although those of ordinary skill in the art will readily recognize that the business rule data can form part of the extracted data or the stored extracted data.

In certain embodiments, the user interface generator 36 can also provide a user-configurable interface that allows a user, such as a developer, analyst, or system administrator, to specify the degree of similarity required for two or more business rule implementations to be considered instances of the same business rule. For example, the user may define via suitable user input 32 a similarity threshold value or select among predefined similarity levels (e.g., strict, moderate, or relaxed). Under a strict similarity level, candidate business rules may be required to match closely in both structure and operations, whereas under a relaxed similarity level the system may treat the business rules as equivalent if they perform substantially the same logical function despite differences in variable names, ordering of operations, or implementation context. Once the similarity threshold has been established, the rule similarity unit 100 compares candidate rule implementations identified during the extraction process and groups those implementations of the candidate business rules that satisfy the specified similarity criteria. Implementations determined to satisfy the similarity threshold may be associated with a single conceptual business rule representation. The business rule identification unit 30 may present the grouped rule implementations to the user through a graphical or programmatic interface, allowing the user to review the identified similarities, confirm or refine the grouping, or adjust the similarity threshold as needed. In this manner, the rule similarity unit 100 enables the rule identification system 10 to identify multiple implementations of candidate business rules and correlate together multiple candidate business rules associated with the same conceptual or reference business rule across different programs, modules, or components of a software application. This capability assists the user in locating all instances of the business rule within the software application, supports maintenance and modification of rule logic, and helps ensure consistent enforcement of the business rules throughout the software application.

The illustrated rule similarity unit 100 can generate similarity data 102 that supports the identification and correlation of multiple implementations of the same business rule. For example, the similarity data 102 can include a similarity score that quantifies the degree of correspondence between candidate business rule implementations, which may be based on syntactic similarity, semantic similarity, data-element correspondence, structural similarity, or a composite of these measures. In addition to similarity scores, the similarity data 102 generated by the rule similarity unit 100 can include groupings of the business rule candidate implementations that satisfy a user-defined similarity threshold, with each group of candidate business rules representing implementations deemed to correspond to the same conceptual or reference business rule. For each group of candidate business rules, the rule similarity unit 100 may also provide mappings to the corresponding programmatic elements, such as code snippets, data elements, operations, relationships, and associated software artifacts, along with metadata identifying the source files, modules, methods, or line positions of the code. The similarity data 102 may also further user-review information, such as lists of potential additional implementations for validation, indications of true positives or false positives, and summaries presented through reports or graphical interfaces. The similarity data 102 enables the users and the system to detect, review, and manage multiple implementations of business rules within a software application.

The illustrated business rule identification unit 30 can also include a rule correlation unit 110 configured to allow the user to select business rules via one or more user interfaces that appear similar or identical and to group those rules together. The rule correlation unit 110 enables the user to review candidate business rules identified by the business rule identification unit 30, either through automated similarity analysis or manual selection, and to establish associations between the business rules that are deemed to represent the same conceptual business rule. For example, the rule correlation unit 110 can present the user with a list of candidate business rules, along with relevant programmatic elements, code snippets, data elements, operations, relationships, and/or associated software artifacts, allowing the user to evaluate the degree of similarity or equivalence among the listed candidate business rules. Once similar or identical rules are selected by the user, the rule correlation unit 110 permits the user to create a grouped representation (e.g., a list) of business rules, thereby consolidating multiple duplicate implementations under a single conceptual business rule. This grouping facilitates improved understanding of the business logic within the software application, assists users (e.g., developers and analysts) in locating all instances of the business rule for maintenance or modification, correlating together duplicate business rules, and helps ensure consistent enforcement of business rules across different programs, modules, or components. In certain embodiments, the grouped business rules may be stored, reported, or presented through a user interface, providing visibility into correlated rule implementations and supporting the identification and elimination of redundant or duplicated business rule logic.

The user may search the application model data 26, which includes business rule data and associated programmatic elements derived from analysis of the source code 12, in order to identify similar or potentially related or duplicate business rules using the rule similarity unit 100. The rule similarity unit 100 is configured to analyze the application model data 26 and evaluate candidate business rule implementations using, for example, one or more similarity techniques, such as comparisons of code snippets, code syntax structures, data elements, operations, relationships, and/or associated software artifacts. Based on this analysis, the rule similarity unit 100 generates similarity data 102, which may include similarity scores, lists of candidate rules, and other information indicative of the degree of similarity among the rules. The similarity data 102 is then provided to the rule correlation unit 110 for further processing.

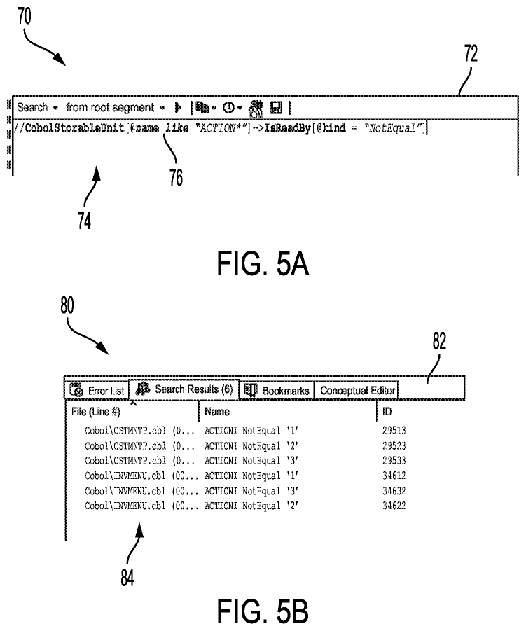

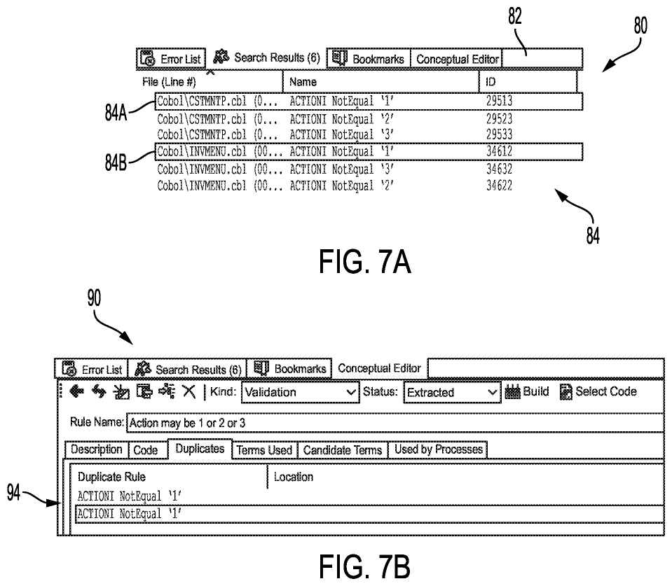

The rule correlation unit 110 may operate in automatic, manual, or a hybrid mode to correlate candidate business rules that appear to represent the same conceptual rule. In the automatic mode, the rule correlation unit can automatically correlate implementations of the candidate business rules satisfying a predefined similarity condition without user intervention. In the manual mode, the rule correlation unit can present candidate implementations to the user through a graphical user interface and the system correlates implementations based on user selection. In the hybrid mode, the rule correlation unit automatically correlates implementations satisfying the predefined similarity condition and presents remaining candidate implementations to the user through a graphical user interface for manual review and selection. As such, the rule correlation unit 110 may automatically correlate business rules that satisfy one or more predefined conditions, such as exceeding a specified similarity threshold or meeting other similarity criteria. In other embodiments, the rule correlation unit 110 may present the discovered or identified candidate rules to the user through a graphical user interface, thereby allowing the user to review and manually determine which rules should be correlated or linked together. For example, as shown in FIG. 5A, the user interface generator 36 may generate a user interface 70 having a window 72 that displays a search field 74. Through this interface, the user may provide user input 32 to the business rule identification unit 30 by entering or selecting a business rule 76 to serve as a reference rule for similarity analysis. In certain embodiments, the selected business rule 76 may be entered manually, selected from a list of known business rules, or otherwise identified within the application model data 26. Alternatively, the rule similarity unit 100 may automatically identify one or more business rules within the application model data 26 for use as reference rules in the similarity search process. Upon receiving the reference business rule, the rule similarity unit 100 searches the application model data 26 and analyzes programmatic elements associated with candidate rule implementations. In particular, the rule similarity unit 100 may evaluate similarities in code syntax structures, code snippets implementing rule logic, data elements referenced by the rule, and other programmatic elements indicative of rule behavior. Based on this analysis, the rule similarity unit 100 generates a set of candidate business rules that satisfy selected similarity criteria. As illustrated in FIGS. 5B and 7A, the user interface generator 36 may generate a user interface 80 including a window 82 that displays a list of similar candidate business rules 84 identified during the similarity analysis. The list of candidate business rules 84 may form part of the similarity data 102 generated by the rule similarity unit 100. The similarity data 102 is then transmitted to and processed by the rule correlation unit 110.

The rule correlation unit 110 enables the correlation or grouping of business rules determined to represent the same or substantially similar business logic. In certain embodiments, the rule correlation unit 110 may automatically select and correlate business rules from the list of candidate business rules 84 that meet predefined correlation conditions. In other embodiments, the rule correlation unit 110 may allow the user to review the candidate rules and manually select those rules that should be considered identical or similar to the reference rule. As shown for example in FIG. 7A, the user can select one or more candidate business rules 84A and 84B from the list of business rules 84. Based on either automated selection or user selection, the rule correlation unit 110 generates rule correlation data 112, which is indicative of correlated or grouped business rules representing multiple or duplicate implementations of the same conceptual or reference rule. For example, FIG. 7B shows the correlation and aggregation of the business rules 84A and 84B selected by the system or use in FIG. 7A for display via the user interface 90. The selected and aggregated business rules are provided in a list 94 that is indicative of duplicate to similar business rules present within the software application. The rule correlation data 112 may be stored in the application model data 26 and/or displayed through an appropriate user interface for review and confirmation by the user.

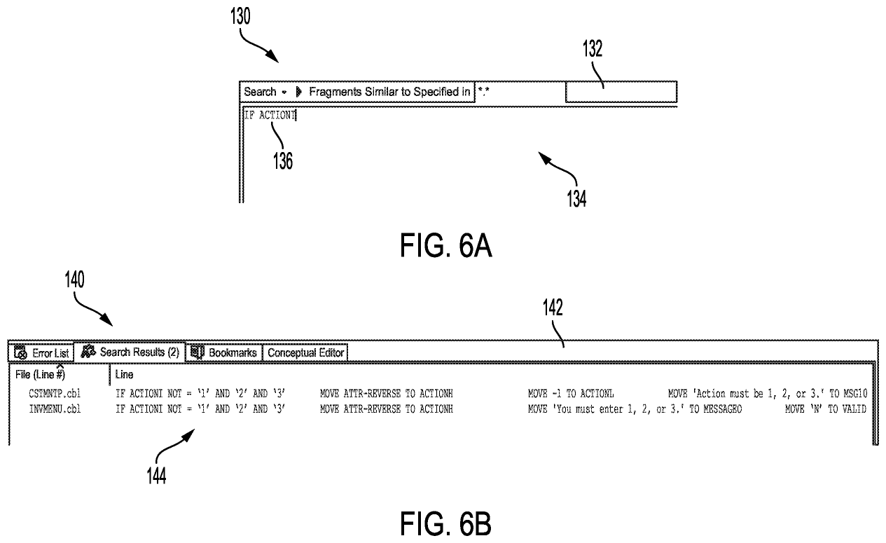

The user or system can also perform a text-based search for business rules in the application model data 26. For example, as shown in FIG. 6A, the user interface generator 36 can generate a user interface 130 that has a window 132 that can display a search field 134. The user can provide user input 32, such as text-based input, into the business rule identification unit 30, and the rule similarity unit 100 can allow the user to input a selected business rule 136 into the search field 134. Alternatively, the rule similarity unit 100 can identify and display one or more business rules. In the current example, the rule similarity unit 100 performs a text-based search of the application model data 26 to provide a list of business rules that meet selected similarity criteria, as noted above. As shown in FIG. 6B, the user interface generator 36 can generate a user interface 140 that has a window 142 that sets forth a list of similar candidate business rules 144. The list of candidate business rules 84 can form part of the similarity data 102 that can then be transmitted and processed by the rule correlation unit 110. The rule correlation unit 110 can allow the user to select the appropriate candidates from the candidate business rules that are either identical or similar to the searched business rule, or the rule correlation unit 110 can automatically select and correlate together multiple business rules from the list 84. The rule correlation unit 110 can generate rule correlation data 112 that is indicative of correlated business rules. The rule correlation data 112 can be displayed on a suitable user interface for review by the user.

The rule identification system 10 of the present invention can also include an optional display unit having the user interface generator 36 for generating and then displaying the user interfaces. The user can interact with the user interface and can provide selections using conventional selection mechanisms (e.g., mouse, keyboard, etc.) one or more user selectable features of the present invention. For example, when the operator desires to create a lineage analysis project or generate a term lineage diagram, then the user can for example select one or more business terms for which the term lineage is to be discovered.

It is to be understood that although the invention has been described above in terms of particular embodiments. The foregoing embodiments are provided as illustrative only and do not limit or define the scope of the invention. Various other embodiments, including but not limited to those described herein are also within the scope of the claims. For example, elements, units, modules, engines, tools and components described herein may be further divided into additional subcomponents or joined together to form fewer components for performing the same functions.

Any of the functions disclosed herein may be implemented using means for performing those functions. Such means include, but are not limited to, any of the components or units disclosed herein, such as the electronic or computing device components described herein.

The techniques described above and below may be implemented, for example, in hardware, one or more computer programs tangibly stored on one or more computer-readable media, firmware, or any combination thereof. The techniques described above may be implemented in one or more computer programs executing on (or executable by) a programmable computer or electronic device having any combination of any number of the following: a processor, non-transitory memory, a storage medium readable and/or writable by the processor (including, for example, volatile and non-volatile memory and/or storage elements), an input device, an output device, and a display. Program code may be applied to input entered using the input device to perform the functions described and to generate output using the output device.

The term computing device or electronic device as used herein can refer to any device that includes a processor and a non-transitory computer-readable memory capable of storing computer-readable instructions, and in which the processor is capable of executing the computer-readable instructions in the memory. The terms computer system and computing system refer herein to a system containing one or more computing devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which affirmatively require an electronic device having a processor, a memory, and storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of identifying and correlating duplicate instances of a business rule within a software application. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

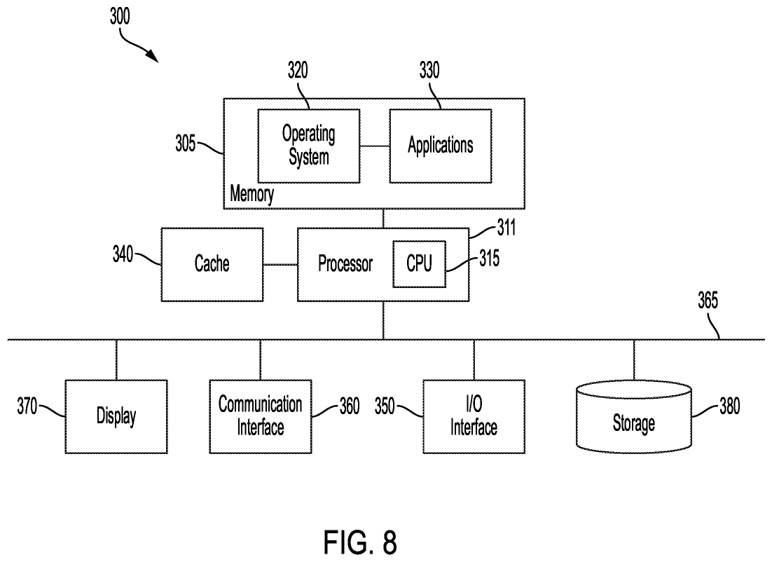

It should be appreciated that various concepts, systems and methods described above can be implemented in any number of ways, as the disclosed concepts are not limited to any particular manner of implementation or system configuration. Examples of specific implementations and applications are discussed below and shown in FIG. 8 primarily for illustrative purposes and for providing or describing the operating environment of the system of the present invention. The rule identification system 10 and/or any associated elements, modules, or units can employ one or more electronic or computing devices, such as one or more servers, clients, computers, laptops, smartphones and the like, that are networked together or which are arranged so as to effectively communicate with each other. The network can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the illustrated electronic or computing device 300. The system 10 or any associated units or components of the system 10 can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 300. In one embodiment, the server may be referred to as a remote machine or a node. In another embodiment, a plurality of nodes may be in the path between any two communicating servers or clients. The rule identification system 10 which includes the data extraction unit 14, the storage unit 18, the application model unit 24, the rule identification unit 30, the rule similarity unit 100, the rule correlation unit 110, and the user interface generator 36 (elements of the system) can be stored on or implemented by one or more of the electronic devices described herein (e.g., clients or servers), and the hardware associated with the electronic devices, such as the processor or CPU and memory described below.

FIG. 8 is a high-level block diagram of an electronic or computing device 300 that can be used with the embodiments disclosed herein. Without limitation, the hardware, software, and techniques described herein can be implemented in digital electronic circuitry or in computer hardware that executes firmware, software, or combinations thereof. The implementation can include a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 300 can be any suitable electronic circuitry that includes a main memory unit 305 that is connected to a processor 311 having a CPU 315 and a cache unit 340 configured to store copies of the data from the most frequently used main memory 305. The electronic device can implement the process flow identification system 10 or one or more elements of the process flow identification system.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 311 is any logic circuitry that responds to, processes or manipulates instructions received from the main memory unit, and can be any suitable processor for execution of a computer program. For example, the processor 311 can be a general and/or special purpose microprocessor and/or a processor of a digital computer. The CPU 315 can be any suitable processing unit known in the art. For example, the CPU 315 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 311 can be embodied in any suitable manner. For example, the processor 311 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 311 can be configured to execute instructions stored in the memory 305 or otherwise accessible to the processor 311. As such, whether configured by hardware or software methods, or by a combination thereof, the processor 311 can represent an entity (e.g., physically embodied in circuitry) capable of performing operations according to embodiments disclosed herein while configured accordingly. Thus, for example, when the processor 311 is embodied as an ASIC, FPGA or the like, the processor 311 can be specifically configured hardware for conducting the operations described herein. Alternatively, as another example, when the processor 311 is embodied as an executor of software instructions, the instructions can specifically configure the processor 311 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 305.

The electronic device 300 applicable to the hardware of the present invention can be based on any of these processors, or any other processor capable of operating as described herein. The central processing unit 315 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

The processor 311 and the CPU 315 can be configured to receive instructions and data from the main memory 305 (e.g., a read-only memory or a random access memory or both) and execute the instructions. The instructions and other data can be stored in the main memory 305. The processor 311 and the main memory 305 can be included in or supplemented by special purpose logic circuitry. The main memory unit 305 can include one or more memory chips capable of storing data and allowing any storage location to be directly accessed by the processor 311. The main memory unit 305 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 305 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 305 can be based on any of the above described memory chips, or any other available memory chips capable of operating as described herein. In the embodiment shown in FIG. 4, the processor 311 communicates with main memory 305 via a system bus 365. The computer executable instructions of the present invention may be provided using any computer-readable media that is accessible by the computing or electronic device 300. Computer-readable media may include, for example, the computer memory or storage unit 305. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 305 is shown within the computing device 300 it will be appreciated that the storage may be distributed or located remotely and accessed via a network or other communication link.

The main memory 305 can comprise an operating system 320 that is configured to implement various operating system functions. For example, the operating system 320 can be responsible for controlling access to various devices, memory management, and/or implementing various functions of the asset management system disclosed herein. Generally, the operating system 320 can be any suitable system software that can manage computer hardware and software resources and provide common services for computer programs.

The main memory 305 can also hold application software 330. For example, the main memory 305 and application software 330 can include various computer executable instructions, application software, and data structures, such as computer executable instructions and data structures that implement various aspects of the embodiments described herein. For example, the main memory 305 and application software 330 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 311 can further be coupled to a database or data storage 380. The data storage 380 can be configured to store information and data relating to various functions and operations of the content characterization systems disclosed herein. For example, as detailed above, the data storage 380 can store information including but not limited to captured information, multimedia, processed information, and characterized content.

A wide variety of I/O devices may be present in or connected to the electronic device 300. For example, the electronic device can include a display 370, and as previously described, the visual application unit 28 or one or more other elements of the system 10 can include the display. The display 370 can be configured to display information and instructions received from the processor 311. Further, the display 370 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 370 can be a smart and/or touch sensitive display that can receive instructions from a user and forwarded the received information to the processor 311. The input devices can also include user selection devices, such as keyboards, mice, trackpads, trackballs, touchpads, touch mice, multi-touch touchpads, touch mice and the like, as well as microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 300 can also include an Input/Output (I/O) interface 350 that is configured to connect the processor 311 to various interfaces via an input/output (I/O) device interface 380. The device 300 can also include a communications interface 360 that is responsible for providing the circuitry 300 with a connection to a communications network (e.g., communications network 120). Transmission and reception of data and instructions can occur over the communications network.

We claim:

1. A system for identifying multiple implementations of a business rule within a software application, comprising
a data extraction unit configured to extract programmatic elements from source code of the software application;
a storage unit configured to store the extracted programmatic elements;
an application model unit configured to generate application model data representing structural and logical relationships among the extracted programmatic elements; and
a business rule identification unit configured to identify, based on the application model data, a plurality of candidate business rules, each of the plurality of candidate business rules associated with one or more implementations in the source code, wherein the business rule identification unit includes
a rule similarity unit configured to evaluate a degree of similarity between implementations of the plurality of candidate business rules, and to generate similarity data indicative of a similarity score quantifying the degree of correspondence between the implementations of the plurality of candidate business rules.

2. The system of claim 1, wherein the business rule identification unit further comprises a rule correlation unit configured to correlate, based on the similarity data, two or more of the implementations of the plurality of business rules to represent the same business rule, and to generate rule correlation data indicative of a grouping of the correlated implementations of the plurality of business rules under a single business rule representation.

3. The system of claim 2, wherein the rule similarity unit is configured to evaluate the extracted programmatic elements to generate the similarity score that quantifies the degree of correspondence between selected ones of the implementations of the plurality of candidate business rules, and wherein the rule similarity unit is further configured to compare the programmatic elements associated with an implementation of a reference business rule with the programmatic elements associated with one or more of the implementations of the plurality of candidate business rules, and based on this comparison, generate the similarity score.

4. The system of claim 3, wherein each of the implementations in the source code includes positional information identifying a location in the source code where the business rule is embodied.

5. The system of claim 3, wherein the programmatic elements includes at least one of data elements, definitions, operations, code snippets, and relationships present in the source code.

6. The system of claim 3, wherein the rule similarity unit is configured to apply a rule similarity technique to the extracted programmatic elements to determine the degree of similarity between the implementations of the plurality of candidate business rules.

7. The system of claim 6, wherein the similarity technique comprises one or more of a syntactic similarity technique, a semantic similarity technique, a data-element similarity technique, and a structural or contextual similarity technique.

8. The system of claim 3, wherein the rule similarity unit is configured to analyze relationships among the programmatic elements, including one or more of control-flow relationships, data-flow relationships, and invocation relationships, that indicate the implementations of the plurality of candidate business rules.

9. The system of claim 7, wherein the rule similarity unit is further configured to generate a composite similarity score by combining similarity scores obtained from two or more of the similarity techniques.

10. The system of claim 3, wherein the rule similarity unit is configured to receive a user-defined similarity threshold and to identify, from the application model data, the implementations of the plurality of candidate business rules satisfying the similarity threshold as potential implementations of a reference business rule.

11. The system of claim 10, further comprising a user interface generator configured to generate a graphical user interface that presents a list of the implementations of the plurality of candidate business rules satisfying the similarity threshold, and that receives user input related to individual ones of the plurality of candidate business rules as implementations of the reference business rule.

12. The system of claim 10, further comprising a user interface generator configured to generate a first user interface having a search field through which a user enters or selects a reference business rule for use as a basis for a code-syntax-based similarity search of the application model data, and to generate a second user interface displaying the plurality of candidate business rules identified as a result of the code-syntax-based similarity search.

13. The system of claim 10, further comprising a user interface generator configured to generate a first user interface having a search field through which a user enters a text-based input as a basis for a text-based similarity search of the application model data, and to generate a second user interface displaying the plurality of candidate business rules identified as a result of the text-based similarity search.

14. The system of claim 5, wherein the data elements include at least one of variables, parameters, constants, fields, attributes, and database columns referenced by the source code; wherein the definitions include at least one of declarations and structural constructs defining data structures, classes, methods, or functions; wherein the operations include at least one of conditional statements, comparison operations, assignment statements, calculations, loops, and function calls that embody validation, computation, or decision logic; and wherein the relationships include at least one of data-flow relationships, derivation relationships, invocation relationships among programs or functions, and control-flow relationships within the source code.

15. The system of claim 3, wherein the rule correlation data is stored in the application model data and is presented through a user interface for review and confirmation by a user.

16. A method for identifying multiple implementations of a business rule within a software application, comprising
extracting, with a data extraction unit, programmatic elements from source code of the software application;
storing the extracted programmatic elements in a storage unit;
generating, with an application model unit, application model data representing structural and logical relationships among the extracted programmatic elements; and
identifying, with a business rule identification unit and based on the application model data, a plurality of candidate business rules, each of the plurality of candidate business rules associated with one or more implementations in the source code; and
evaluating, with a rule similarity unit forming part of the business rule identification unit, a degree of similarity between implementations of the plurality of candidate business rules and generating similarity data indicative of a similarity score quantifying the degree of correspondence between the implementations of the plurality of candidate business rules.

17. The method of claim 16, further comprising correlating, with a rule correlation unit forming part of the business rule identification unit and based on the similarity data, two or more of the implementations of the plurality of business rules to represent the same business rule, and generating rule correlation data indicative of a grouping of the correlated implementations of the plurality of business rules under a single business rule representation.

18. The method of claim 17, further comprising, with the rule similarity unit,
evaluating the extracted programmatic elements to generate the similarity score by quantifying a degree of correspondence between selected ones of the implementations of the plurality of candidate business rules,
comparing the programmatic elements associated with an implementation of a reference business rule with the programmatic elements associated with one or more of the implementations of the plurality of candidate business rules, and
based on this comparison, generating the similarity score.

19. The method of claim 18, further comprising applying, with the rule similarity unit, a rule similarity technique to the extracted programmatic elements to determine the degree of similarity between the implementations of the plurality of candidate business rules.

20. The method of claim 19, wherein the similarity technique comprises one or more of a syntactic similarity technique, a semantic similarity technique, a data-element similarity technique, and a structural or contextual similarity technique.

21. The method of claim 20, further comprising generating, with the rule similarity unit, a composite similarity score by combining similarity scores obtained from two or more of the similarity techniques.

22. The method of claim 18, further comprising identifying from the application model data, with the rule similarity unit when receiving a user-defined similarity threshold, the implementations of the plurality of candidate business rules satisfying the similarity threshold as potential implementations of a reference business rule.

23. The method of claim 22, further comprising
generating, with a user interface generator a graphical user interface that presents a list of the implementations of the plurality of candidate business rules satisfying the similarity threshold, and
receiving user input related to individual ones of the plurality of candidate business rules as implementations of the reference business rule.

24. The method of claim 22, further comprising
generating, with a user interface generator, a first user interface having a search field through which a user enters or selects a reference business rule for use as a basis for a code-syntax-based similarity search of the application model data, and
generating, with the user interface generator, a second user interface displaying the plurality of candidate business rules identified as a result of the code-syntax-based similarity search.

25. The method of claim 22, further comprising
generating, with a user interface generator, a first user interface having a search field through which a user enters a text-based input as a basis for a text-based similarity search of the application model data, and
generating, with the user interface generator, a second user interface displaying the plurality of candidate business rules identified as a result of the text-based similarity search.

26. A non-transitory computer-readable medium storing computer program instructions that, when executed by at least one processor, cause the at least one processor to perform operations for identifying multiple implementations of a business rule within a software application, the operations comprising:
extracting programmatic elements from source code of the software application;
generating application model data representing structural and logical relationships among the extracted programmatic elements;
identifying, based on the application model data, a plurality of candidate business rules, wherein each of the plurality of candidate business rules associated with one or more implementations in the source code; and
evaluating a degree of similarity between implementations of the plurality of candidate business rules, and
generating similarity data indicative of a similarity score quantifying the degree of correspondence between the implementations of the plurality of candidate business rules.

27. The non-transitory computer-readable medium of claim 26, further comprising
correlating, based on the similarity data, two or more of the implementations of the plurality of business rules to represent the same business rule, and
generating rule correlation data indicative of a grouping of the correlated implementations of the plurality of business rules under a single business rule representation.

28. The non-transitory computer-readable medium of claim 27, further comprising
evaluating the extracted programmatic elements to generate the similarity score by quantifying a degree of correspondence between selected ones of the implementations of the plurality of candidate business rules,
comparing the programmatic elements associated with an implementation of a reference business rule with the programmatic elements associated with one or more of the implementations of the plurality of candidate business rules, and
based on this comparison, generating the similarity score.

29. The non-transitory computer-readable medium of claim 28, further comprising applying a rule similarity technique to the extracted programmatic elements to determine the degree of similarity between the implementations of the plurality of candidate business rules.

30. The non-transitory computer-readable medium of claim 29, wherein the similarity technique comprises one or more of a syntactic similarity technique, a semantic similarity technique, a data-element similarity technique, and a structural or contextual similarity technique.

31. The method of claim 30, further comprising generating a composite similarity score by combining similarity scores obtained from two or more of the similarity techniques.

32. The method of claim 28, further comprising identifying from the application model data, when receiving a user-defined similarity threshold, the implementations of the plurality of candidate business rules satisfying the similarity threshold as potential implementations of a reference business rule.

33. The non-transitory computer-readable medium of claim 32, further comprising
generating a graphical user interface that presents a list of the implementations of the plurality of candidate business rules satisfying the similarity threshold, and
receiving user input related to individual ones of the plurality of candidate business rules as implementations of the reference business rule.

34. The non-transitory computer-readable medium of claim 32, further comprising
generating a first user interface having a search field through which a user enters or selects a reference business rule for use as a basis for a code-syntax-based similarity search of the application model data, and
generating a second user interface displaying the plurality of candidate business rules identified as a result of the code-syntax-based similarity search.

35. The non-transitory computer-readable medium of claim 32, further comprising
generating a first user interface having a search field through which a user enters a text-based input as a basis for a text-based similarity search of the application model data, and
generating a second user interface displaying the plurality of candidate business rules identified as a result of the text-based similarity search.
